(19) United States
(12) Patent Application Publication
(10) Pub. No.: US 2010/0030647 A1
(43) Pub. Date: Feb. 4, 2010

(54) ADVERTISEMENT SELECTION FOR INTERNET SEARCH AND CONTENT PAGES

(75) Inventor: Ben Shahshahani, Menlo Park, CA (US)

Correspondence Address: FIALA & WEAVER, P.L.L.C.;C/O CPA GLOBAL, P.O. BOX 52050, MINNEAPOLIS, MN, 55402, US

(73) Assignee: YAHOO! INC., Sunnyvale, CA (US)

(21) Appl. No.: 12/183,221

(22) Filed: Jul. 31, 2008

(51) Int. Cl. G06Q 30/00

(52) U.S. Cl. 705/14.66

(57) ABSTRACT

Advertisements are selected for display on search results pages or web pages displaying requested content. A request associated with a user is received for an advertisement, such as for display on a search results page or a content-displaying web page. Profile information associated with the user is identified. An inverted index is queried based on the identified profile information. The inverted index includes a list of user attributes and a list of at least one advertisement and corresponding weight factor that correspond to each listed user attribute. A plurality of advertisements is determined in the inverted index based on the query. The determined advertisements are filtered to generate an advertisement presentation configuration that includes at least one of the identified advertisements.

### BACKGROUND OF THE INVENTION

1. Field of the Invention

The present invention relates to the selection of advertisements for display in online web pages.

2. Background

According to one definition, advertising is a paid, one-way communication through a medium in which an advertiser is identified, and the message (i.e., the advertisement) provided by the advertiser is controlled. Advertising may be performed for a variety of purposes, including publicity, public relations, product placement, sponsorship, underwriting, and sales promotion. A variety of mediums are used to convey an advertisement, including television, radio, movies, magazines, newspapers, the Internet, and billboards.

Online Advertising relates to the promoting of products and services using the Internet and World Wide Web. Typical online advertisement types include banner ads, floating ads, pop-up ads, and video ads which are provided through a browser to the user's computer desktop. A large segment of online advertising is untargeted. Typically, online advertisement strategy involves placing an advertisement on the computer desktop of as many computer users as possible, in the hopes that at least a few computer users will be interested. Such untargeted advertising tends to be inefficient, and may be annoying to many computer users whose computer desktop may seem cluttered with undesired and uninteresting advertisements.

“Contextual advertising” refers to a form of Internet advertising/marketing where advertisements are selected and served by automated systems based on content displayed to the user. For example, a contextual advertisement selection system may scan the text of a webpage for keywords, and select advertisements based on any keywords located in the text. When the webpage is displayed for the user, contextual advertisement selection system provides the selected advertisements for display on the webpage.

“Sponsored search” refers to a form of Internet advertising/marketing that enables advertisers to increase their visibility in the results page of a search engine query. According to sponsored search, an advertiser may pay or provide other compensation for having an advertisement appear in a sponsored section of the results page for one or more particular queries. A user who enters one of the queries into the search engine is provided with a results page that includes the advertisement in the sponsored search section. The sponsored search section is prominently displayed in the results page, to enable the user to easily see and interact with the advertisement. In this manner, an advertiser is enabled to provide advertisements to users that are directly related to their queries.

Because sponsored search advertisements are selected based on submitted queries, and contextual advertisements are selected based on a viewed content, they can still fail in many cases to be of high interest to users. Thus, what is desired are more effective ways of providing advertisements of interest to computer users.

### BRIEF SUMMARY OF THE INVENTION

Advertisements are selected for display on a user's search results pages or on web pages that display content requested by the user. Such advertisements are selected in a manner that takes into account attributes of the user.

In one implementation, a method for selecting advertisements is provided. A request associated with a user is received for an advertisement. The request may result from a search query entered by the user or a request for content entered by the user. Profile information associated with the user is identified. An inverted index is queried based on the identified profile information. The inverted index includes a list of user attributes and a list of at least one advertisement and corresponding weight factor that correspond to each listed user attribute. A plurality of advertisements is determined in the inverted index. The determined advertisements are filtered to generate an advertisement presentation configuration that includes at least one of the determined advertisements.

In another implementation, a system for selecting advertisements is provided. The system includes a front end module, an inverted index querier, and an advertisement filter. The front end module is configured to receive a request associated with a user for an advertisement and to identify profile information associated with the user. The inverted index querier is configured to query an inverted index based on the identified profile information. The inverted index includes a list of user attributes and a list of at least one advertisement and corresponding weight factor that correspond to each listed user attribute. The inverted index querier is configured to identify a plurality of advertisements in the inverted index based on the query. The advertisement filter is configured to filter the identified advertisements to generate an advertisement configuration that includes at least one of the identified advertisements.

In another implementation, methods for generating an inverted index for selecting advertisements are provided. A feature table is received that includes a list of features. Each feature in the list of features includes a user attribute, an advertisement attribute, and a weight factor associated with the user attribute and advertisement attribute. The list of features is mapped to a plurality of advertisements to generate an index. An inverted index is generated from the generated index. The inverted index lists each user attribute included in the feature table and includes a list for each user attribute of advertisement and weight factor pairs.

In still another implementation, a system for indexing user and advertisement information is provided. The system includes an advertisement index generator and an index inverter. The advertisement index generator is configured to receive a feature table that includes a list of features. Each feature in the list of features includes a user attribute, an advertisement attribute, and a weight factor associated with the user attribute and advertisement attribute. The advertisement index generator is configured to map the list of features to a plurality of advertisements to generate an index. The index inverter is configured to generate an inverted index from the generated index that lists each user attribute included in the feature table and includes a list for each user attribute of advertisement and weight factor pairs.

Computer program products are also described herein. The computer program products include a computer-readable medium having computer program logic recorded thereon for enabling a processing unit to select advertisements based on an inverted index, and/or to generate an inverted index.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 shows a block diagram of a computer that a user may use to view content.

FIG. 2 shows an example search results page that may result from a user submitting a query to a search engine.

FIG. 3 shows a block diagram of an information retrieval system in which contextual advertising and sponsored search may be implemented.

FIG. 4 shows an example query that may be submitted by a computer user to a search engine.

FIG. 5 shows a block diagram of an advertisement engine, according to an example embodiment of the present invention.

FIG. 6 shows an example of an inverted index, according to an embodiment of the present invention.

FIG. 7 shows an example advertisement and weight factor pair, according to an embodiment of the present invention.

FIG. 8 shows a block diagram of a computer system in which an advertisement engine may be located, according to an example embodiment of the present invention.

FIG. 9 shows a block diagram of an advertisement selection system, according to an example embodiment of the present invention.

FIG. 10 shows a flowchart for selecting advertisements, according to an example embodiment of the present invention.

FIG. 11 shows a block diagram of a system for a front-end module to determine user profile information, according to an example embodiment of the present invention.

FIG. 12 shows a block diagram of an advertisement filter, according to an example embodiment of the present invention.

FIG. 13 shows a flowchart for generating an inverted index, according to an example embodiment of the present invention.

FIG. 14 shows a system for generating an inverted index, according to an example embodiment of the present invention.

FIG. 15 shows an example feature table, according to an embodiment of the present invention.

FIG. 16 shows an advertisements table, according to an embodiment of the present invention.

FIG. 17 shows an example advertisement index, according to an embodiment of the present invention.

FIG. 18 shows an example inverted index, according to an embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

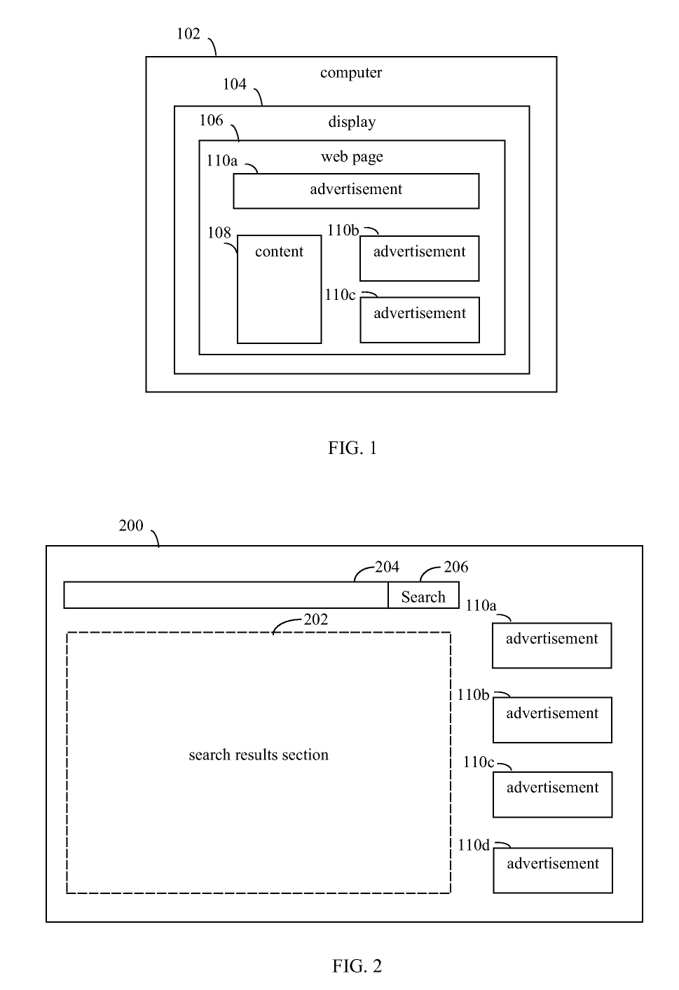

Embodiments of the present invention relate to online advertising, such as advertising in the form of contextual advertising and sponsored search. FIGS. 1 and 2 show examples of the displaying of advertisements in contextual advertising and sponsored search environments. For instance, FIG. 1 shows a block diagram of a computer 102 that a user may use to view content 108. As shown in FIG. 1, computer 102 has a display 104 that displays a web page 106. For example, web page 106 may be open in a web browser. The user may cause web page 106 to be displayed in any manner, including navigating to web page 106 according to a URL (uniform resource locator) address for web page 106. As shown in FIG. 1, web page 106 includes content 108 that the user has caused to be displayed by navigating to web page 106. Furthermore, web page 106 may include any number and arrangement of advertisements, including advertisements 110a-110c shown in FIG. 1. Advertisements 110a-110c may be displayed according to any suitable form, including as banner ads, floating ads, pop-up ads, and video ads. In the example of FIG. 1, advertisement 110a is shown as a banner ad at the top of web page 106, and advertisements 110b and 110c are both positioned adjacent to a right edge of web page 106. Advertisements 110a-110c may be selected for display by searching on text included in content 108, and selecting advertisements that are related to keywords found in the searched text.

FIG. 2 shows an example search results page 200 that may result from a user submitting a query to a search engine. Search results page 200 may be displayed by computer 102 of FIG. 1 in a similar manner as web page 106. Search results page 200 is typically a web page, and may be presented to the user by the search engine. As shown in FIG. 2, search results page 200 includes a search results section 802, a data entry box 204, and a search button 206. Data entry box 204 defines a user-editable area into which one or more query terms may be entered. Search button 206 comprises an interface element that, when activated by a user, causes the search engine to execute a document search based on the query term(s) entered in data entry box 204. Search results section 202 is used to display information about documents identified by the search engine in response to the submitted search query.

Search results page 200 may include any number and arrangement of advertisements, including advertisements 110a-110d shown in FIG. 2. Advertisements 110a-110d may be displayed in search results page 200 according to any suitable form, including as banner ads, floating ads, pop-up ads, text ads, and video ads. In the example of FIG. 2, advertisements 110a-110d are displayed in a column adjacent to a right edge of web page 106. Advertisements 110a-110d may each be sponsored search ads provided by advertisers. An advertiser may pay or provide other compensation for having one or more of advertisements 110a-110d appear in a sponsored section of search results page 200 for one or more particular queries.

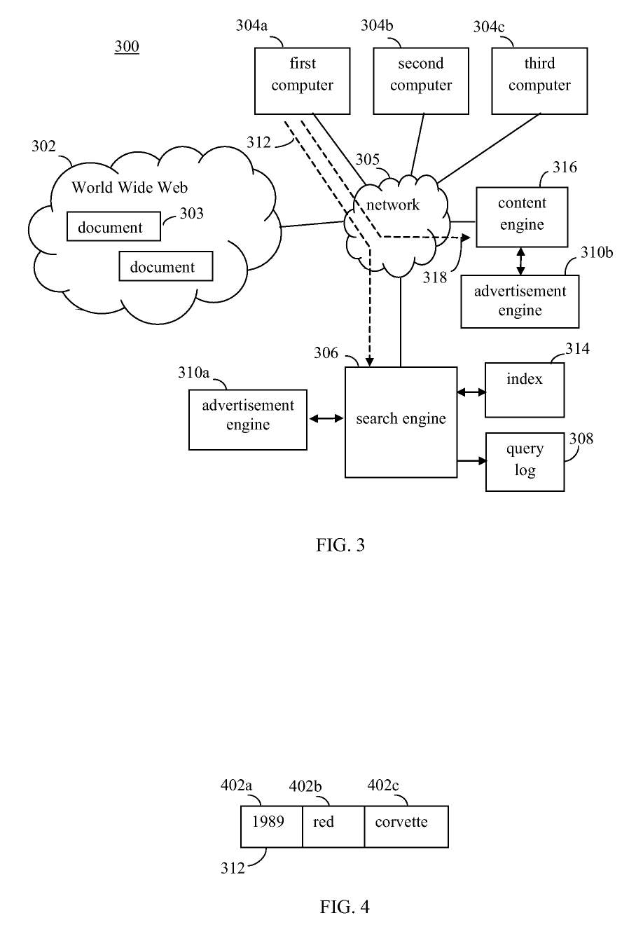

Various types of advertisement selection systems may be used to select advertisements for display on web pages in contextual advertising and sponsored search applications. For instance, FIG. 3 shows a block diagram of an information retrieval system 300 in which contextual advertising and sponsored search may be implemented. System 300 is described herein for illustrative purposes only, and it is noted that embodiments of the present invention may be implemented in alternative environments.

As shown in FIG. 3, system 300 includes a search engine 306 and a content engine 316. One or more computers 304, such as first computer 304a, second computer 304b and third computer 304c, are connected to a communication network 305. Network 305 may be any type of communication network, such as a local area network (LAN), a wide area network (WAN), or a combination of communication networks. In embodiments, network 305 may include the Internet and/or an intranet. Computers 304 can retrieve documents from entities over network 305. In embodiments where network 305 includes the Internet, a collection of documents, including a document 303, which form a portion of World Wide Web 302, are available for retrieval by computers 304 through network 305. On the Internet, documents may be identified/located by a uniform resource locator (URL), such as http://www.yahoo.com, and/or by other mechanisms. Computers 304 can access document 303 through network 305 by supplying a URL corresponding to document 303 to a document server (not shown in FIG. 3).

Search engine 306 is coupled to network 305. A user of computer 304a who desires to retrieve one or more documents relevant to a particular topic, but does not know the identifier/location of such a document, may submit a query 312 to search engine 306 through network 305. Search engine 306 receives query 312, and analyzes an index 314 to identify documents relevant to query 312. For example, search engine 306 may identify a set of documents indexed by index 314 that include terms of query 312. The set of documents may include any number of documents, including tens, hundreds, thousands, or even millions of documents. Search engine 306 may use a ranking or relevance function to rank documents of the retrieved set of documents in an order of relevance to the user. Documents of the set determined to most likely be relevant may be provided at the top of a list of the returned documents in an attempt to avoid the user having to parse through the entire set of documents.

The list of the returned documents may be provided to a user in the context of a search results page, such as search results page 200 shown in FIG. 2. In one implementation, responsive to the activation of such a user interface element (e.g., clicking on a hyperlink) in the search results page by a user, search engine 306 will cause the returned document associated with the user interface element to be presented to the user. The presentation may involve the delivery of the document from a document server (not shown in FIG. 3) to any one of user computers 304a-304c.

FIG. 4 shows an example query 312 that may be submitted by a user of one of computers 304a-304c of FIG. 3 to search engine 306. As shown in FIG. 4, query 312 includes one or more terms 402, such as first term 402a, second term 402b and third term 402c. Any number of terms 402 may be present in a query. As shown in FIG. 4, terms 402a, 402b and 402c of query 312 are “1989,” “red,” and “corvette,” respectively. Search engine 306 applies these terms 402a-402c to index 314 to retrieve a document locator, such as a URL, for one or more indexed documents that match “1989,” “red,” and “corvette,” and may order the list of documents according to a ranking.

As also shown in FIG. 3, search engine 306 may generate a query log 308. Query log 308 is a record of searches that are made using search engine 306.

As shown in FIG. 3, an advertisement engine 310a may be coupled to search engine 306 to enable sponsored search advertising. As described above with respect to FIG. 2, one or more advertisements 110 may be displayed in search results page 200. The advertisements may be selected by advertisement engine 310a. For instance, search engine 306 may provide query 312 to advertisement engine 310a. Advertisement engine 310a may search an advertisement database for one or more advertisements to display for one or more particular query terms in query 312. Advertisement engine 310a may transmit one or more advertisements selected based on query 312 to search engine 306 to be included in the search results page provided to the user in response to query 312.

Content engine 316 is coupled to network 305. A user of computer 304a who desires to view online content may submit a content request 318 to content engine 316 through network 305. For example, the content request 318 may be in the form of a clicked link or URL address entered into a web browser. Content engine 316 receives content request 318, and transmits a web page corresponding to content request 318 back to computer 304a to be viewed by the user at computer 304a. For example, the web page transmitted to computer 304a may be similar to web page 106 shown in FIG. 1.

As shown in FIG. 3, an advertisement engine 310b may be coupled to content engine 316 to enable contextual advertising. As described above with respect to FIG. 1, one or more advertisements 110 may be displayed in web page 106. The advertisements may be selected by advertisement engine 310b. For instance, search engine 306 may provide text of content 108 to advertisement engine 310b. Advertisement engine 310a may search scan the text of content 108 for keywords, and select an advertisement from an advertisement database based on any located keywords. Advertisement engine 310b may transmit one or more advertisements selected based on content 108 to content engine 316 to be included in the web page provided to the user in response to content request 318.

Search engine 306, content engine 316, advertisement engine 310a, and advertisement engine 310b may each be implemented in hardware, software, firmware, or any combination thereof. For example, search engine 306, content engine 316, advertisement engine 310a, and advertisement engine 310b may each include software/firmware that executes in one or more processors of one or more computer systems, such as one or more servers. Examples of search engine 306 that are accessible through network 305 include, but are not limited to, Yahoo! Search™ (at http://www.yahoo.com), Ask.com™ (at http://www.ask.com), and Google™ (at http://www.google.com). Advertisement engine 310a may be an advertisement engine associated with Yahoo! Search™, Ask.com™, Google™, or other search engine. Examples of content engine 316 include content engines for any number of websites that provide content in the form of news and/or information, including Yahoo! (www.yahoo.com), MSNBC (www.msnbc.com), The New York Times (nytimes.com), Dictionary.com (www.dictionary.com), etc. Advertisement engine 310b may be an advertisement engine associated with Yahoo!, MSNBC, The New York Times, Dictionary.com or other online content source.

Note that advertisement engines 310a and 310b enable advertisements to be selected based on search queries or requested content, but fail to take into account attributes of the user. Thus, advertisement engines 310a and 310b can still fail in many cases to select advertisements of high interest to users. Embodiments of the present invention overcome these limitations. Example embodiments for advertisement selection that take into account user information are described in the following section.

### B. Example Embodiments for Advertisement Selection

Embodiments of the present invention enable advertisements to be selected for display to users that take into account user information. In sponsored search and contextual advertising environments, it is desired to select advertisements for display that have the highest expected revenue. To select advertisements with high expected revenue, an advertisement engine is configured to find a set of advertisements having high click probability. In embodiments, machine learning models are trained to predict advertisement click probability, and parameters of the models are stored in an inverted index that may be accessed and evaluated relatively quickly at a time at which advertisements are to be served.

Machine learning models are trained that predict the probability of a user clicking on an advertisement by extracting and weighting features that combine various attributes of the user, advertisement, presentation, and world state. These features are grouped into several categories of features. One of the feature categories includes those features that are conjunctions of predicates on user attributes and predicates on advertisement attributes. A distributed inverted index is generated that uses these features, where the key to the inverted index is predicates on the user attributes. At runtime, user attributes are extracted for a user, and a dictionary of user predicates is used to obtain the set of keys that are used to query the inverted index. A list of candidate advertisements with high probability of being clicked may be extracted from the inverted index. The list of candidate advertisements can be filtered (e.g., reordered, reduced in size, etc.) using other features.

A runtime system can extract a list of advertisements having high probability of being clicked using the parameters of the click model that are stored in the inverted index. This probability combined with a bid amount that each advertiser is willing to pay for clicks on its advertisements allows the runtime system to estimate an expected revenue for each advertisement. The expected revenue can be balanced with other factors, such as impact on the user, to determine which advertisements, an order of advertisements, and/or a presentation layout for displaying the advertisement to the user.

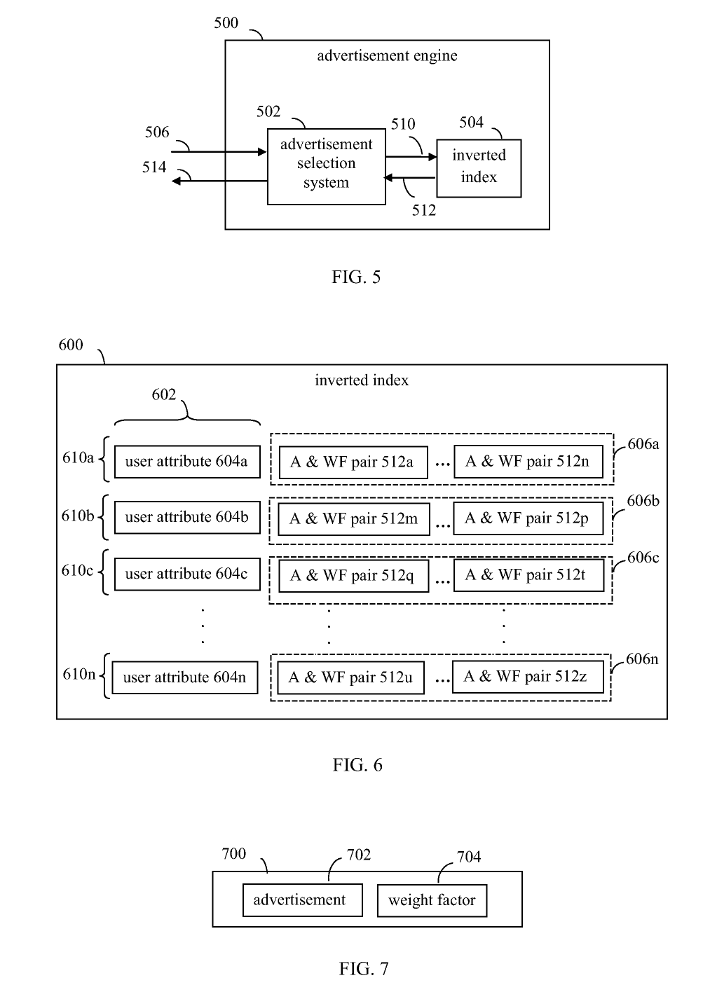

For instance, FIG. 5 shows a block diagram of an advertisement engine 500, according to an example embodiment of the present invention. Advertisement engine 500 is similar to advertisement engines 310a and 310b, with differences described as follows. Advertisement engine 500 may be configured to handle advertisements for search engine 306, content engine 316, and/or other entities. As shown in FIG. 5, advertisement engine 500 includes an advertisement selection system 502. Advertisement selection system 502 is configured to select advertisements. Advertisement selection system 502 is described as follows.

As shown in FIG. 5, advertisement selection system 502 receives an advertisement request 506. For example, advertisement request 506 may be received from a search engine, such as search engine 306 of FIG. 3, a content engine, such as content engine 316 of FIG. 3, or from other online source that desires advertisements for display. For instance, advertisement request 506 may have been received from a search engine in the case where a user submitted a query to the search engine, and the search engine is configured to provide advertisements for display on the search results page corresponding to the query. In another situation, advertisement request 506 may have been received from a content engine if a user submitted a request for content to the content engine, and the content engine is configured to provide advertisements for display on the web page that provides the requested content.

Advertisement selection system 502 is configured to determine user profile information based on advertisement request 506. Such user profile information may include one or more attributes of the user associated with advertisement request 506. Any number and type of attributes of the user may be determined from advertisement request 506, including a location of the user, whether the user is male or female, information on websites of interest to the user, information on hobbies/interests of the user, etc. Advertisement selection system 502 may use any one or more determined attributes of the user to select one or more advertisements for the user that the user may be likely to interact with (e.g., click on).

Advertisement selection system 502 is configured to access an inverted index 504 to determine the one or more advertisements to be provided for display to the user associated with advertisement request 506. As shown in FIG. 5, advertisement selection system 502 accesses inverted index 504 with one or more user attributes 510 determined from advertisement request 506. User attributes 510 are used as one or more keys for inverted index 504. For each key, inverted index 504 may return a corresponding list of one or more advertisement and weight factor pairs 512.

For instance, FIG. 6 shows an inverted index 600, which is an example of inverted index 504, according to an embodiment of the present invention. As shown in FIG. 6, inverted index 600 includes a plurality of records 610a-610n. In embodiments, inverted index 600 may include any number of records 610. Each record 610 includes a corresponding user attribute 604 and an associated list 606 of advertisement and weight factor pairs 512. In the example of FIG. 6, user attributes 604a-604n are present. Each list 606 may include any number of one or more pairs 512. For instance, in the example of FIG. 6, list 606a associated with user attribute 604a includes pairs 512a-512n, list 606b associated with user attribute 604b includes pairs 512m-512p, list 606c associated with user attribute 604c includes pairs 512q-512t, and list 606n associated with user attribute 604n includes pairs 512u-512z.

FIG. 7 shows an example advertisement and weight factor pair 700, which is an example of one of advertisement and weight factor pairs 512 shown in FIG. 6. As shown in FIG. 7, advertisement and weight factor pair 700 includes an advertisement 702 and a weight factor 704. Advertisement 702 identifies an advertisement and may include further information regarding the identified advertisement, including a portion or entirety of the advertisement itself. Weight factor 704 is a weight factor indicative of a weight to be given to a conjunction of advertisement 702 and user attribute 604 associated with pair 700.

Referring back to FIG. 5, inverted index 504 is accessed with one or more user attributes 510 by advertisement selection system 502. For each user attribute 510 used to access inverted index 504, the corresponding list of advertisement and weight factor pairs 512 is extracted from inverted index 504. For instance, referring to the example of FIG. 6, if inverted index 600 is accessed with user attribute 604b, list 606b of advertisement and weight factor pairs 512m-512p is extracted. If inverted index 600 is accessed with user attributes 604a and 604c, lists 606a and 606c of advertisement and weight factor pairs 512a-512n and 512q-512t, respectively, are extracted.

In some cases, an advertisement may be extracted a single time in response to the one or more user attributes 510 used to access inverted index 504. In such case, the advertisement may have a single associated weight factor from the extracted advertisement and weight factor pair 512. In other cases, an advertisement may be extracted multiple times in response to the one or more user attributes 510 used to access inverted index 504. In such case, the advertisement may have multiple associated weight factors from the multiple extracted advertisement and weight factor pairs 512. For instance, as described above, if inverted index 600 is accessed with user attributes 604a and 604c, lists 606a and 606c of advertisement and weight factor pairs 512a-512n and 512q-512t are extracted. In an example, the advertisement of advertisement and weight factor pair 512c (list 606a) and the advertisement of advertisement and weight factor pair 512r (list 606c) may be the same advertisement. Thus, the advertisement has multiple weight factors—a first weight factor in advertisement and weight factor pair 512c and a second weight factor in advertisement and weight factor pair 512r. In such case, a weight factor score associated with the advertisement may be determined as a sum of the weight factors associated with the advertisement. In the current example, the weight factor score associated with the advertisement is the sum of the first and second weight factors in the advertisement and weight factor pairs 512c and 512r extracted from lists 606a and 606c for the advertisement. In embodiments, any number of weight factors may be summed to determine a total weight factor for an advertisement, depending on the number of extracted lists 606 that include the advertisement.

As described further below, advertisements may be ranked based on their weight factors. The ranking of an advertisement having multiple weight factors may be based on the sum of the extracted weight factors associated with the advertisement. In one example, a list of a number “N” of top ranked advertisements, where “N” may be any value (e.g., 512), may be sorted according to final scores associated with the advertisements. The final score determined for each advertisement may be a single weight factor (for advertisements appearing on one list 606) or the sum of the weight factors (for advertisements appearing in more than one list 606) associated with the advertisement, as described above.

Advertisement selection system 502 receives the one or more extracted lists of advertisement and weight factor pairs 512. Advertisement selection system 502 processes the received advertisement and weight factor pairs 512 to select one or more advertisements 702 (FIG. 7) of the received pairs 512 to be transmitted to the requesting entity. Such processing by advertisement selection system 502 may include removing one or more advertisements 702 from consideration, ranking advertisements 702 of the received pairs 512, and determining a display presentation of advertisements 702. Such removing, ranking, and presentation determining may be performed based on a variety of factors, such as one or more user attributes, one or more advertisement attributes, world state attributes, or other factors. Such factors are described in detail further below.

As shown in FIG. 5, advertisement selection system 502 generates a configured advertisements list 514. Configured advertisements list 514 includes one or more advertisements 702 identified in pairs 512 that is/are ranked in terms of likelihood of being clicked on by the user. Configured advertisements list 514 is transmitted to the requesting entity (e.g., search engine 306 or content engine 316). The requesting entity receives configured advertisements list 514, and transmits a web page with advertisements to be displayed according to configured advertisements list 514.

Note that advertisement engine 500, including advertisement selection system 800, may be implemented in hardware, software, firmware, or any combination thereof. For example, advertisement selection system 502 may be implemented in hardware logic, and/or may include software/firmware that executes in one or more processors of one or more computer systems, such as one or more servers. Advertisement engine 500, including advertisement selection system 502 and inverted index 504, may be positioned in any suitable location(s).

For instance, FIG. 8 shows a block diagram of a computer system 800 in which advertisement engine 500 may be located, according to an example embodiment of the present invention. As shown in FIG. 8, computer system 800 includes a server 802 and storage 804. Storage 804 is coupled to server 802. Advertisement selection system 502 is implemented in server 802, such as in the form of software code that runs on server 802. Inverted index 504 may be stored in storage 804, and advertisement selection system 502 may access storage 804 to access inverted index 504. Storage 804 may include any number of one or more storage devices, including hard disc drives, optical disc drives, memory devices, or other types of storage mentioned elsewhere herein or otherwise known.

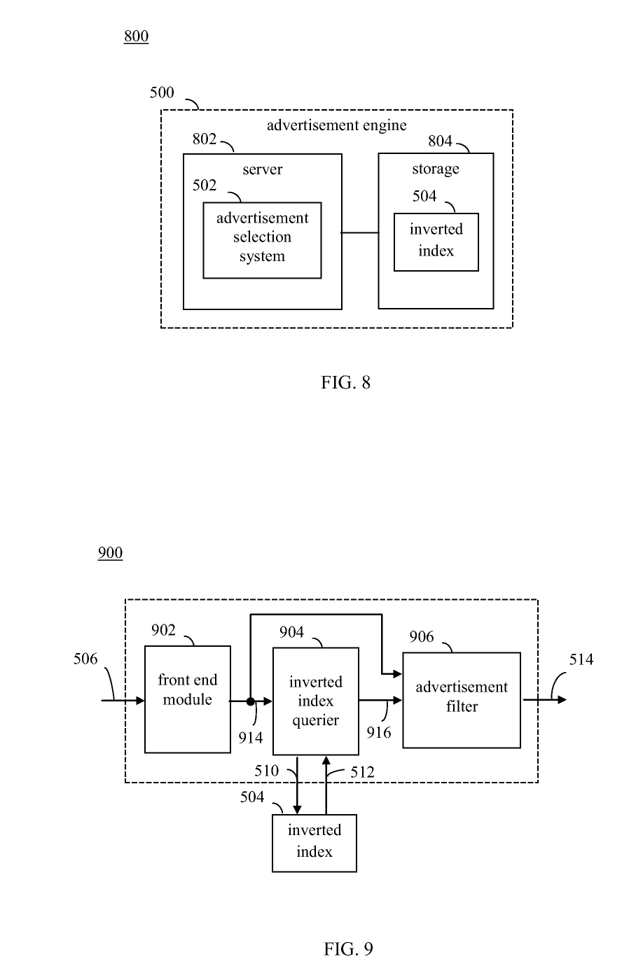

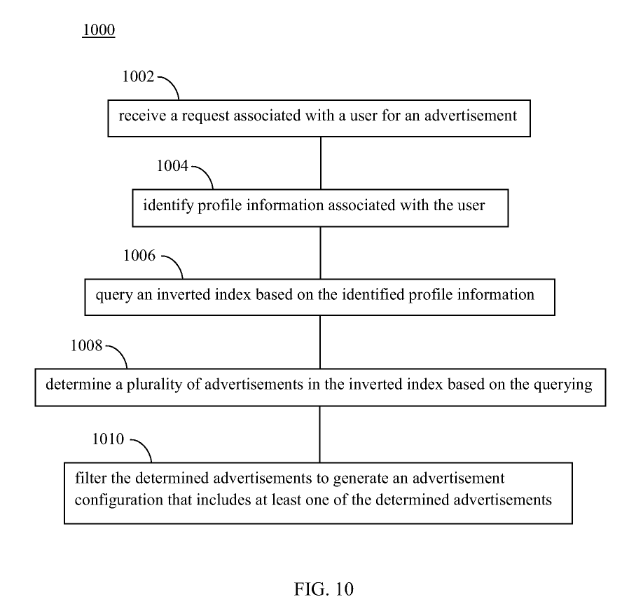

Advertisement selection system 502 may be implemented in a variety of ways to perform its functions. For example, FIG. 9 shows a block diagram of an advertisement selection system 900, according to an example embodiment of the present invention. Advertisement selection system 900 is an example of advertisement selection system 502 shown in FIG. 5. As shown in FIG. 9, advertisement selection system 900 includes a front-end module 902, an inverted index querier 904, and an advertisement filter 906. System 900 is described as follows with respect to FIG. 10. FIG. 10 shows a flowchart 1000 for selecting advertisements, according to an example embodiment of the present invention. System 900 may operate according to flowchart 1000, for example. Further structural and operational embodiments will be apparent to persons skilled in the relevant art(s) based on the discussion regarding flowchart 1000. Flowchart 1000 is described as follows.

Flowchart 1000 begins with step 1002. In step 1002, a request associated with a user is received for an advertisement. For example, as shown in FIG. 9, front end module 902 receives advertisement request 506, which may be received from a search engine (e.g., search engine 306 of FIG. 3), content engine (e.g., content engine 316), or other entity. In addition to indicating a request for one or more advertisements, request 506 may include various information regarding the user, including identifying information for the user (e.g., IP address of the user's computer) and information from one or more web browser-associated cookies stored on the user's computer (e.g., computer 304a shown in FIG. 3). When request 506 relates to a search engine query, request 506 may include the one or more terms included in the query by the user. When request 506 relates to a content request, request 506 may include information from the content requested by the user (e.g., a link to the content, text of the content, etc.).

In step 1004, profile information associated with the user is identified. For example, front-end module 902 may determine profile information associated with the user. As described above with respect to FIG. 5, such user profile information may include one or more attributes of the user associated with advertisement request 506. Any number and type of attributes of the user may be determined from request 506, including a location of the user, whether the user is male or female, information on websites of interest to the user, information on hobbies/interests of the user, terms in the search query submitted by the user or the web page being viewed by the user, etc.

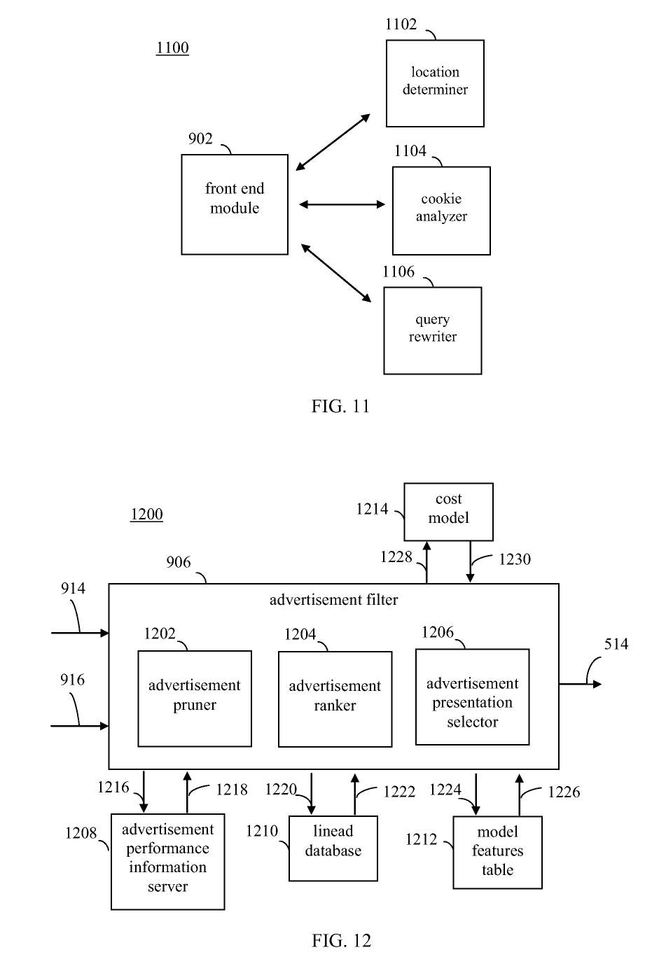

For instance, FIG. 11 shows a block diagram of a system 1100 for front-end module 902 to determine user profile information, according to an example embodiment of the present invention. As shown in FIG. 11, system 1100 includes front end module 902, a location determiner 1102, a cookie analyzer 1104, and a query rewriter 1106. Any one or more of location determiner 1102, cookie analyzer 1104, and query rewriter 1106 may be present, in embodiments. In an embodiment, location determiner 1102, cookie analyzer 1104, and/or query rewriter 1106 may be located externally to front end module 902, and may be accessed by front end module 902 over a network (e.g., a LAN, WAN, the Internet, etc.). Alternatively, location determiner 1102, cookie analyzer 1104, and/or query rewriter 1106 may be internal modules to front end module 902, and/or may be located on a same computer system as front end module 902. Location determiner 1102, cookie analyzer 1104, and query rewriter 1106 of system 1100 are described as follows.

Location determiner 1102 is configured to determine location information regarding the user. For instance, in an embodiment, front end module 902 may transmit information of request 506 to location determiner 1102, such as the IP address of the computer of the user, query terms submitted by the user (in the case of search query), and/or content requested by the user (in the case of a content request). Location determiner 1102 analyzes the received information of request 506 to determine location information regarding the user, including a physical location of the user, a location of interest to the user, and/of further types of location information. For instance, location determiner 1102 may determine a location of the user (e.g., a location of the computer of the user) by analyzing the IP address of the computer of the user. In the case of a search query, location determiner 1102 may determine a location of the user, or a location of interest to the user, by parsing the terms of the submitted query to determine whether location terms were included. For instance, a user may have submitted a query including the terms “pizza Sunnyvale” to locate a pizza restaurant in Sunnyvale, Calif. Location determiner 1102 may determine the location “Sunnyvale” by parsing the query terms. In the case of a content request, location determiner 1102 may determine a location of the user, or a location of interest to the user, by parsing text of the content (e.g., content 108 of FIG. 1) requested by the user. Location determiner 1102 may transmit the determined location information to front end module 902 as determined user location attributes.

Cookie analyzer 1104 is configured to determine behavioral and/or demographic information regarding the user from one or more cookies. For instance, in an embodiment, front end module 902 may transmit information of request 506 to cookie analyzer 1104, including information from one or more web browser-associated cookies stored on the user's computer. Alternatively, cookie analyzer 1104 may extract cookie information directly from the computer of the user. Cookie analyzer 1104 analyzes the received cookie information to determine behavioral and/or demographic information regarding the user. Examples of behavioral information that may be determined include hobbies and interests of the user, which may be determinable from click through rates (CTR) information and other information regarding web browsing by the user that is stored in or otherwise ascertainable from the received cookie information. Analysis of web browsing activity by the user as indicated by the cookie information may be used to generate a long-term direct response (LTDR) score and/or a short-term direct response score (STDR) for various behaviors of the user that may be used for further behavioral analysis. Techniques for generation of such scores will be known to persons skilled in the relevant art(s). Examples of demographic information that may be determined from the received cookie information include an age (and/or age group) of the user, a gender of the user, an income level of the user, a nationality of the user, and/or further types of demographic information. Cookie analyzer 1104 may be configured to determine behavioral and/or demographic information regarding the user in various ways, including using natural language processing (NLP) and/or machine learning (ML) techniques, as would be known to persons skilled in the relevant art(s). Cookie analyzer 1104 may transmit the determined behavioral and/or demographic information to front end module 902 as determined behavioral and/or demographic user attributes.

Query rewriter 1106 is configured to rewrite one or more query terms input by a user (in the case of a search query) into one or more semantically similar query terms. For example, this may be performed because the query terms input by the user are not recognizable and/or processable by system 900. For instance, in an embodiment, front end module 902 may transmit query terms in request 506 to query rewriter 1106. Query rewriter 1106 analyzes the received query terms, and if the received query terms are not usable by system 900, rewrites the query terms into semantically similar query terms that are recognizable by system 900. Query rewriter 1106 may transmit the determined semantically similar query terms to front end module 902 and/or location determiner 1102.

Front end module 902 collects the determined user profile information, including determined user location attributes (e.g., determined by location determiner 1102), determined user behavioral attributes (e.g., determined by cookie analyzer 1104), determined user demographic attributes (e.g., determined by cookie analyzer 1104), query terms (e.g., as received in request 506 and/or semantically similar query terms determined by query rewriter 1106), and/or any further determined user attributes. As shown in FIG. 9, the determined user profile information is output by front end module 902 as user profile information 914.

Referring back to flowchart 1000 (FIG. 10), in step 1006, an inverted index is queried based on the identified profile information and the received query. For example, as shown in FIG. 9, inverted index querier 904 receives user profile information 914. Inverted index querier 904 is configured to query inverted index 504 based on the one or more user attributes received in user profile information 914. Inverted index querier 904 may be configured to access inverted index 504 as described above with respect to FIGS. 5-7 for advertisement selection system 502. Inverted index querier 904 queries inverted index 504 to determine one or more advertisements that may be provided for display to the user associated with request 506. As shown in FIG. 9, inverted index querier 904 accesses inverted index 504 with one or more user attributes 510 received in user profile information 914.

In step 1008, a plurality of advertisements in the inverted index is determined based on the querying. Inverted index querier 904 is configured to identify one or more advertisements (e.g., advertisements 702 of FIG. 7) in inverted index 504 based on the querying of step 1006. As described above, one or more user attributes 510 are used as one or more keys for inverted index 504. For each key, inverted index 504 may return a corresponding list of one or more advertisement and weight factor pairs 512. As shown in FIG. 9, inverted index querier 904 outputs the returned advertisement and weight factor pairs 512 as advertisements 916.

As described above, advertisements may be ranked based on their weight factors. The ranking of an advertisement having multiple weight factors may be based on the sum of the extracted weight factors associated with the advertisement. In an embodiment, inverted index querier 904 may be configured to determine a total weight factor score for each advertisement returned from inverted index 504, including summing weight factors for each advertisement that appears in multiple lists and thus has multiple associated weight factors. Inverted index querier 904 may be configured to sort the advertisements based on their total weight factors scores, and to output advertisements 916 according to this sorting.

In step 1010, the determined advertisements are filtered to generate an advertisement configuration that includes at least one of the determined advertisements. For example, as shown in FIG. 9, advertisement filter 906 receives advertisements 916, which includes one or more advertisements and corresponding weight factors. Advertisement filter 906 may also optionally receive user profile information 914. Advertisement filter 906 is configured to filter advertisements 916 as described above (with respect to FIG. 5), which may include removing one or more advertisements from consideration, ranking the received advertisements, and configuring a presentation of the advertisements. Such removing, ranking, and presentation configuration may be performed based on a variety of factors, such as one or more user attributes received in user profile information 914, one or more attributes of the received advertisement, one or more world state attributes, the weight factors corresponding to the advertisements, and/or based on other factors. Filtering can also be based on business logic. For example, an advertisement may be filtered because the advertiser account is low in funds, or may be filtered based on category, such as an “adult” category of advertisement. As shown in FIG. 9, advertisement 906 outputs the filtered advertisements as configured advertisements list 514.

### C. Example Features Used for Advertisement Filtering

Advertisement filter 906 shown in FIG. 9 may be configured to filter advertisements based on various types of attributes, including user attributes, advertisement attributes, world state attributes, presentation attributes, a relevance of the user, advertisement, and/or world state attributes to each other (“relevance attributes”), and/or further attributes. Examples of these types of attributes are described as follows.

User attributes: As described above, a variety of attributes related to users exist, including user location attributes (e.g., as determined by location determiner 1102), user behavioral attributes (e.g., as determined by cookie analyzer 1104), user demographic attributes (e.g., as determined by cookie analyzer 1104), query terms (e.g., as received in request 506 and/or semantically similar query terms determined by query rewriter 1106), attributes of a query such as a query category, etc. A user attribute may be indicated as θᵤ. A user attribute may be expressed in a function as f(θᵤ), for example. A variety of functions f(θᵤ) may be generated based on user attributes.

For example, a user attribute θᵤ may be gender. An example function f(θᵤ) on a gender user attribute may be a function “gender=male,” which may be evaluated by an indicator function to be true or false. For a particular user related to an advertisement request 506, the gender user attribute may be determined to be “female.” Thus, in this case, function “gender=male” is evaluated to be false.

Advertisement attributes: An advertisement attribute is an attribute of an advertisement that may be displayed. A variety of advertisement attributes exist, including words in a title of an advertisement, a category of advertisement, words in the body of an advertisement, etc. For example, an advertisement category attribute may be “sports,” “health,” “electronics,” “sports cars,” etc. An advertisement attribute may be indicated as θₐ. Similarly to a user attribute, an advertisement attribute may be expressed in a function as f(θₐ) (e.g., “advertisement category=entertainment”)

World state attributes: A world state attribute is an attribute of the environment. A variety of world state attributes exist, including time-related attributes such as time of day local to the user, portion of day (morning, afternoon, evening, nighttime, etc.), day of week, month, year, and season of year (summer, fall, winter, spring), holiday (Christmas, Halloween, etc.), weather-related attributes (rain, snow, etc.), etc. A world state attribute may be indicated as □. A world state attribute may be expressed in a function as f(□) (e.g., “season=winter”).

Note that functions may be based on a world state attribute combined with a user attribute or advertisement attribute. For example, a function f(θᵤ, □) is a function based on both a user attribute θᵤ and a world state attribute □. A function f(θₐ, □) is a function based on both an advertisement attribute θₐ and a world state attribute □. The functions f(θᵤ), f(θᵤ, □), f(θₐ), f(θₐ, □), and f(□) are categorized as a first type of function or “feature” that may be used for advertisement filtering.

A second type of function or feature that may be used for advertisement filtering relates to the relevance attributes mentioned above. The second type of feature is based on conjunctions of predicates on user attributes and predicates on advertisement attributes. The second type of feature incorporates a user attribute and an advertisement attribute, and may optionally include a world state attribute, which are related to each other in the form of a logical “AND” function. For example, a user attribute θᵤ and an advertisement attribute θₐ may each be expressed in a relevance feature as f(θᵤ, θₐ) (or as f(θᵤ, θₐ, □) when a world state attribute is also included). The relevance feature may include an “AND” function of a function of the user attribute θᵤ as g(θᵤ) and a function of the advertisement attribute θₐ as h(θₐ), expressed as Equation 1 below:

f(νᵤ, θₐ)=I(g(θᵤ)) AND I(h(θₐ)), Equation 1

where
I( ) is an indicator function.
   A wide variety of such relevance feature may be generated. For example, g(θᵤ) may be the function “‘Ipod’ in query,” and h(θₐ) may be the function “‘Apple’ in advertisement title.” According to the “AND” function, if both “‘Ipod’ in query” and “‘Apple’ in advertisement title” are true, f(θᵤ, θₐ) is true. In another example, (θᵤ) may be the function “‘Ipod’ in query,” and h(θₐ) may be the function “‘orchard’ in advertisement title.” According to the “AND” function, if both “‘Ipod’ in query” and “‘orchard’ in advertisement title” are true, f(θᵤ, θₐ) is true.

As described above, user attributes may include behavioral attributes. An example second type of feature that incorporates a user behavioral attribute is shown as follows: LTDR_sport>0.8 AND ad_category=sport. For this example, if the user attribute “LTDR_sport,” is greater than 0.8, which is an indication that the user has a relatively high interest in sports, and the category of the advertisement (ad_category) is “sport,” then the feature function is true.

A third type of function or feature that may be used for advertisement filtering also relates to the relevance attributes mentioned above. The third type of feature incorporates a user attribute and an advertisement attribute, and may optionally include a world state attribute, which are related to each other in a manner that is non-factorizable (not expressible) by a logical “AND” function. Similarly to the second type of feature, a user attribute θᵤ and an advertisement attribute θₐ may be expressed according to the third type of feature in a relevance feature as f(θᵤ, θₐ) (or as f(θᵤ, θₐ, □) when a world state attribute is also included). However, the relevance feature does not include an “AND” function, and instead contains other function of the user attribute θᵤ and of the advertisement attribute θₐ. A wide variety of such relevance feature may be generated. For instance, a relevance feature f(θᵤ, θₐ) may evaluate a fraction of the words in the user query (θᵤ) that is found in the title of the advertisement (θₐ). In another example, a relevance feature f(θᵤ, θₐ) may evaluate whether a location of the words in the user query (θᵤ) is different from a location of the same words in the title of the advertisement (θₐ).

A fourth type of function or feature that may be used for advertisement filtering relates to advertisement presentation. The fourth type of feature incorporates a user attribute and a presentation attribute (π), and may optionally include a world state attribute and/or an advertisement attribute and a presentation attribute, etc. A user attribute θᵤ and a presentation attribute π may be expressed according to the fourth type as a feature f(θᵤ, π) (or as f(θᵤ, π, □) when a world state attribute is also included). A feature f(θᵤ, π) is configured to evaluate attributes of the layout of presentation of advertisements to the user. Examples of presentation attributes include a total number of advertisements to be displayed to the user on a resulting web page (e.g., search results page, content results page, etc.), a particular placement of advertisements on the resulting web page, a number of advertisements in the same advertisement category as a current advertisement to be displayed on the resulting web page, etc.

### D. Example Advertisement Filtering Embodiments

Advertisement filter 906 may be configured to perform advertisement filtering based on one or more of the four types of features described above in a variety of ways. For instance, FIG. 12 shows a block diagram of a system 1200 for advertisement filter 906 to perform advertisement filtering, according to an example embodiment of the present invention. As shown in FIG. 12, system 1200 includes advertisement filter 906, an advertisement performance information server 1208, a linead database 1210, a model features table 1212, and a cost model 1214. Any one or more of advertisement performance information server 1208, linead database 1210, model features table 1212, and cost model 1214 may be present, in embodiments. In an embodiment, advertisement performance information server 1208, linead database 1210, model features table 1212, and/or cost model 1214 may be accessed by advertisement filter 906 over a network (e.g., a LAN, WAN, the Internet, etc.). Alternatively, advertisement performance information server 1208, linead database 1210, model features table 1212, and/or cost model 1214 may be local to advertisement filter 906. As shown in FIG. 12, advertisement filter 906 includes an advertisement pruner 1202, an advertisement ranker 1204, and an advertisement presentation selector 1206. System 1200 is described as follows.

As shown in FIG. 12, advertisement filter 906 receives advertisements 916 and optionally receives user profile information 914. Advertisement pruner 1202 is configured to determine whether any of advertisements 916 should be “pruned” (e.g., removed), and thus not provided for display. Advertisement pruner 1202 may be configured to perform the pruning of advertisements based on various types of attributes, such as those described above. For example, in an embodiment, advertisement pruner 1202 may be configured to determine whether to remove any advertisements based on the first and third features described above.

For instance, advertisement pruner 1202 may determine whether to remove any advertisement based on the first feature functions of f(θᵤ) based on a user attribute, f(θᵤ, □) based on a combination of user and world state attributes, f(θₐ) based on an advertisement attribute, f(θₐ, □) based on a combination of advertisement and world state attributes, and/or f(□) based on world state attributes. Additionally or alternatively, advertisement pruner 1202 may determine whether to remove any advertisement based on the third feature functions of f(θᵤ, θₐ) based on a combination of user and advertisement attributes and/or f(θᵤ, θₐ, □) based on a combination of user, advertisement, and world state attributes.

For illustrative purposes, an example of advertisements 916 that may be received by advertisement filter 906 is shown as follows in Table 1:

TABLE 1

| Advertisement Title | Weight Factor |
|---|---|
| After Shave Brand U | 0.3 |
| Sports Gear Store X | 0.8 |
| Cheap Apple Ipods Available | 0.7 |
| Apple Orchards | 0.2 |

This example of advertisements 916 may have been generated as described above by front end module 902 and inverted index querier 904 shown in FIG. 9. As shown above, advertisements 906 includes an advertisement title and a corresponding weight factor (e.g., as provided by advertisement and weight factor pairs 512 and 700 shown in FIGS. 6 and 7). Note that the weight factors listed in Table 1 may be sums of weight factors associated with the corresponding advertisement (e.g., appearing in multiple extracted lists 606), as described above. Advertisement pruner 1202 may determine whether to remove any of the above listed advertisements based on any number of one or more first and third feature functions.

For example, a third feature function g(θᵤ, θₐ) may be configured to evaluate a whether a fraction of the words in a user query (θᵤ) that is found in the title of the advertisement (θₐ) is greater than or equal to 25%. An example query that may have been provided by the user, and included in user profile information 914, may be “Apple Ipod.” This third feature function g(θᵤ, θₐ) may be applied to the advertisements listed in Table 1 for this example query. With regard to the first listed advertisement, the fraction of words in the user query “Apple Ipod” in the title “After Shave Brand U” is 0, and thus less than 25%. Therefore, advertisement pruner 1202 may be configured to remove the first advertisement. With regard to the second listed advertisement, the title “Sports Gear Store X” has 0% of the words of query “Apple Ipod.” Thus, advertisement pruner 1202 may be configured to remove the second advertisement. However, the third and fourth advertisement titles “Cheap Apple Ipods Available” and “Apple Orchards” respectively have 25% and 50% of the words of query “Apple Ipod.” Thus, advertisement pruner 1202 may not remove the third and fourth advertisements. Alternatively, the score of each advertisement may be changed by using the weights of these new features, the advertisements may be reordered accordingly, and the top “N” ads may be selected.

Advertisement ranker 1204 is configured to determine a ranking of advertisements 916. The determined ranking may be used for various reasons, including being used in conjunction with advertisement pruner 1202 to pare down the number of advertisements in advertisements 916. For example, advertisement ranker 1204 may rank advertisements 916 into a ranked list, and advertisement pruner 1202 may remove a number of lowest ranked advertisements of the list such that a desired number remains.

Advertisement ranker 1204 may be configured to determine the ranking based on various factors, including based on weight factors and/or various types of attributes, such as those attributes described above. For example, in an embodiment, advertisement ranker 1204 may be configured to determine the ranking based on the first and third features described above. For instance, advertisement ranker 1204 may determine the ranking according to the first feature functions of f(θᵤ) based on a user attribute, f(θᵤ, □) based on a combination of user and world state attributes, f(θₐ) based on an advertisement attribute, f(θₐ, □) based on a combination of advertisement and world state attributes, and/or f(□) based on world state attributes. Additionally or alternatively, advertisement ranker 1204 may determine the ranking according to the third feature functions of f(θᵤ, θₐ) based on a combination of user and advertisement attributes and/or f(θᵤ, θₐ, □) based on a combination of user, advertisement, and world state attributes.

The example of advertisements 916 shown in Table 1 above is repeated in Table 2 as follows:

TABLE 2

| Advertisement Title | Weight Factor |
|---|---|
| After Shave Brand U | 0.3 |
| Sports Gear Store X | 0.8 |
| Cheap Apple Ipods Available | 0.7 |
| Apple Orchards | 0.2 |

Advertisement ranker 1204 may determine a ranking for the above listed advertisements (assuming that pruner 1202 did not remove any advertisements in the list, or has not yet executed) based on the weight factor column and/or on any number of one or more first and third feature functions.

For example, a third feature function h(θᵤ, θₐ) may be configured to rank advertisements based on a fraction of the words in a user query (θᵤ) that is found in the title of the advertisement (θₐ). The example query of “Apple Ipod” referenced above is used again here for illustrative purposes. The first-fourth advertisements in Table 1 respectively include 0%, 0%, 50%, and 25%, of the words of the query “Apple Ipod.” Thus, advertisement ranker 1204 may rank the four advertisements as shown below in Table 3 (where the rankings of the third and fourth advertisements are interchangeable).

TABLE 3

| Ranking | Advertisement Title | Weight Factor |
|---|---|---|
| 1 | Cheap Apple Ipods Available | 0.7 |
| 2 | Apple Orchards | 0.2 |
| 3 | After Shave Brand U | 0.3 |
| 4 | Sports Gear Store X | 0.8 |

Advertisement presentation selector 1206 is configured to determine a presentation of advertisements 916. A determined presentation may indicate where particular advertisements are to be positioned in a web page displayed to the user. Advertisement presentation selector 1206 may be configured to perform further ranking of advertisements 916, which may be used to aid in determining the display arrangement for advertisements 916 in a web page. For example, a highest ranked advertisement of advertisements 916 may be displayed in a prominent position, such as an upper most banner location. Lesser ranked advertisements of advertisements 916 may be positioned in correspondingly less prominent web page advertisement locations, such as in a right side list of advertisements that shows higher ranked advertisements at the top of the right side list, and lower ranked advertisements at the bottom of the right side list. Advertisement presentation selector 1206 may be configured to determine the presentation based on various types of attributes, such as those described above. For example, in an embodiment, advertisement presentation selector 1206 may be configured to determine the presentation based on the fourth type of features described above.

For instance, advertisement presentation selector 1206 may determine the display presentation according to the fourth feature functions of f(θᵤ, π) based on a combination of user and presentation attributes or (θᵤ, π, □) based on a combination of user, presentation, and world state attributes. For example, advertisement presentation selector 1206 may determine a presentation based on a combination of user attributes with presentation attributes such as a total number of advertisements to be displayed to the user on a resulting web page (e.g., search results page, content results page, etc.), a particular placement of advertisements on the resulting web page, a number of advertisements in the same advertisement category as a current advertisement to be displayed on the resulting web page, cost factors related to the advertisements to be displayed, click through rates of the advertisements to be displayed, etc.

For example, a fourth feature function i(θᵤ, π) may be configured to determine a display arrangement for advertisements in a search results web page based on a search query entered by a user (θᵤ) with only 1 advertisement per advertisement category allowed (π). The example query of “Apple Ipod” referenced above may have been used, and advertisements 916 may have been generated to include advertisements from both of Ebay® and Amazon.com®. Advertisements 916 may have been ranked (e.g., by advertisement ranker 1204) to place the Ebay® and Amazon.com® advertisements respectively as 1 and 2 at the top of the list. The Ebay® and Amazon.com®) advertisements may be both categorized as “online merchant” advertisements. Advertisement presentation selector 1206 executes function i(θᵤ, π) as described above on the advertisements. Because function i(θᵤ, π) only allows 1 advertisement per advertisement category for the user's search results web page, one of the Ebay® and Amazon.com® advertisements must be filtered (e.g., removed) from the display presentation. In the current example, because the Ebay® advertisement is higher ranked than the Amazon.com® advertisement, the Amazon.com® advertisement may be filtered out, and the Ebay® advertisement may be included in the output configured advertisements list 514.

Note that any one or more of advertisement performance information server 1208, linead database 1210, model features table 1212, and/or cost model 1214 may be accessed by any one or more of advertisement pruner 1202, advertisement ranker 1204, and advertisement presentation selector 1206 to determine advertisement attributes. Advertisement performance information server 1208, linead database 1210, model features table 1212, and cost model 1214 are described as follows.

Advertisement performance information server 1208a is a feedback server that provides runtime information about how advertisements are performing. For example, a request 1216 may be transmitted from advertisement filter 906 to server 1208 that includes a query and an advertisement identifier. Server 1208 transmits a response 1218 to advertisement filter 906 that includes performance information, such as a number of times the identified advertisement was previously presented in response to the query, and of that number, how many times a click was made by a user on the advertisement. Thus, a runtime estimate of click through rate (CTR) may be determined for the advertisement. The CTR may be used as an advertisement attribute for the advertisement, which may be included in features used by advertisement pruner 1202, advertisement ranker 1204, and/or advertisement presentation selector 1206.

Linead (line ad) database 1210 is a database of advertisements. Each record in linead database 1210 corresponds to a unique advertisement, and includes information submitted by the corresponding advertiser, such as creative, bid terms, bid price, etc. A request 1220 may be transmitted from advertisement filter 906 to a server that includes linead database 1210. Request 1220 may provide an advertisement identifier. The server transmits a response 1222 to advertisement filter 906 that includes one or more of the bid terms, bid price, etc. The bid terms, bid price, etc., may be used as an advertisement attribute for the advertisement, which may be included in features used by advertisement pruner 1202, advertisement ranker 1204, and/or advertisement presentation selector 1206.

Model features table 1212 may be a table that contains parameters of a model that is used for scoring advertisements for a query. The model may be a click probability model or other suitable model. For example, model features table 1212 may be a two-dimensional table, with rows that include feature identifiers, and columns that are weights for the features. For example, a feature may be: word w1 is in the query and word w2 is in the title of the advertisement. A request 1224 that includes one or more features and weights may be transmitted from advertisement filter 906 to a server that includes model features table 1212. The server transmits a response 1226 to advertisement filter 906 that includes one or more advertisement scores. The advertisement scores may be used by advertisement pruner 1202, advertisement ranker 1204, and/or advertisement presentation selector 1206 to respectively prune, rank, and/or determine a presentation of advertisements.

Cost model 1214 is a cost model that may be used to decide how to present a set of advertisements on a resulting web page, such as a search results page, including one or more of how many ads to present on the top of the page, how many ads to present on a side bar, etc. The cost model refers essentially to a cost of web page real estate that an advertisement is going to occupy. For example, there may be a value “x” for a top position on the search results web page, and an advertisement may be allowed to occupy the top position if its score multiplied by price is greater than the value “x.” A request 1228 that includes one or more ranking scores or weights for corresponding advertisements may be transmitted from advertisement filter 906 to a server that includes cost model 1214. The server transmits a response 1230 to advertisement filter 906 that includes a determined arrangement of advertisements for the resulting web page. The arrangement may be used by advertisement presentation selector 1206 to determine a presentation of advertisements.

### E. Example Embodiments for Generating an Inverted Index

As described above, inverted index 504 is accessed to select one or more advertisements associated with a particular user attribute. Inverted index 600 shown in FIG. 6, and described above, is an example of inverted index 504 shown in FIGS. 5, 8 and 9. Inverted index 504 (including inverted index 600) may be generated in various ways.

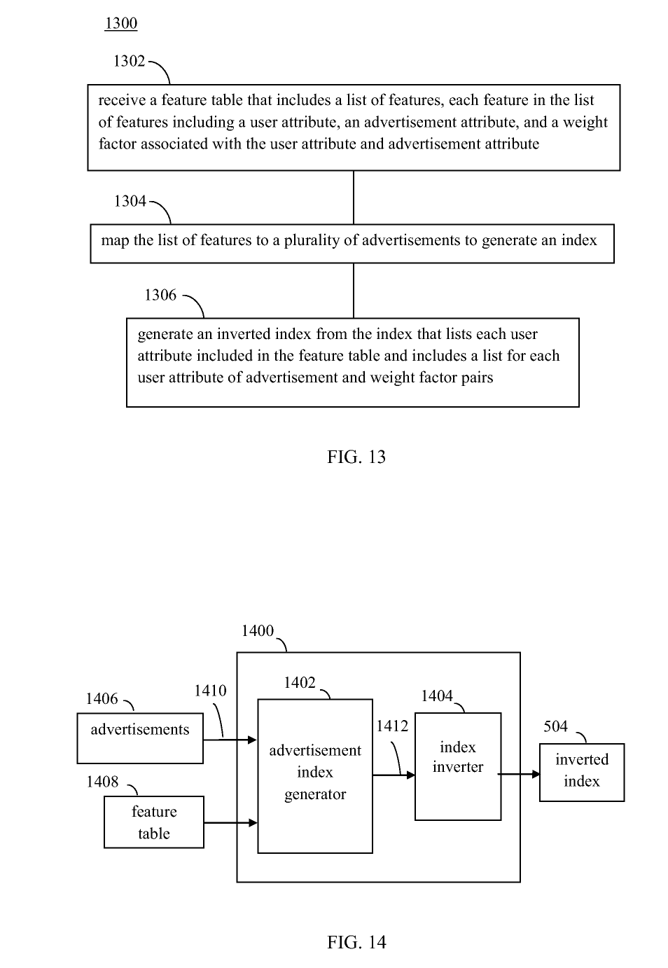

For instance, FIG. 13 shows a flowchart 1300 for generating an inverted index, according to an example embodiment of the present invention. For example, inverted indexes 504 and 600 may be generated according to flowchart 1300. Flowchart 1300 is described below with respect to FIG. 14. FIG. 14 shows a system 1400 for generating an inverted index, according to an example embodiment of the present invention. As shown in FIG. 14, system 1400 includes an advertisement index generator 1402 and an index inverter 1404. System 1400 may operate according to flowchart 1300, for example. Further structural and operational embodiments will be apparent to persons skilled in the relevant art(s) based on the discussion regarding flowchart 1300. Flowchart 1300 is described as follows.

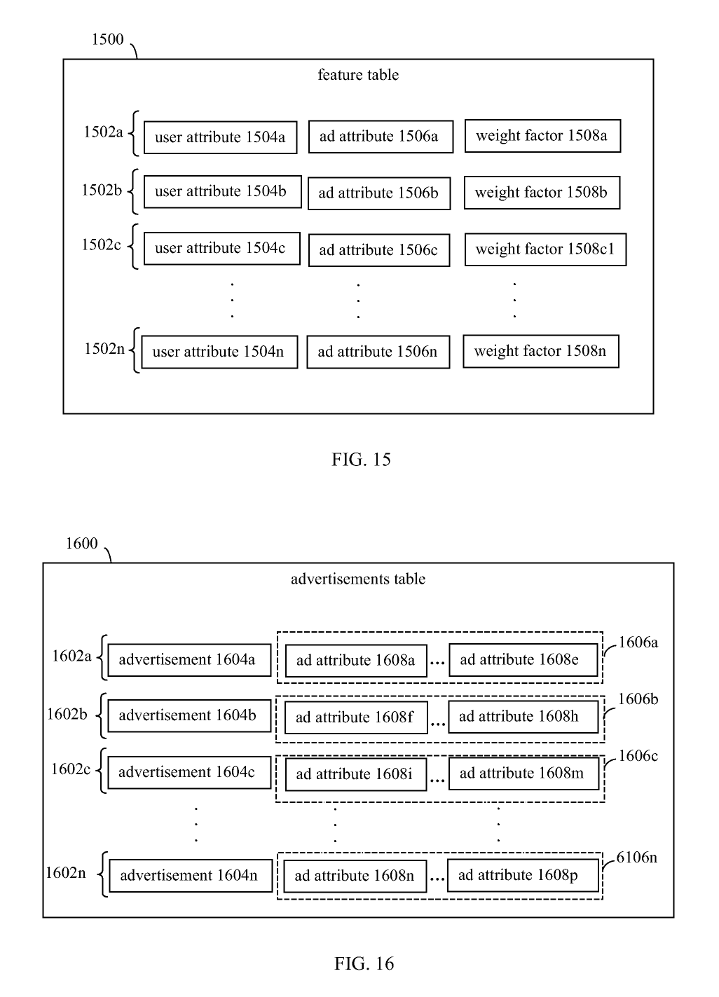

Flowchart 1300 begins with step 1302. In step 1302, a feature table is received that includes a list of features, each feature in the list of features including a user attribute, an advertisement attribute, and a weight factor associated with the user attribute and advertisement attribute. For example, in an embodiment, advertisement index generator 1402 shown in FIG. 14 may receive a feature table 1408. FIG. 15 shows a feature table 1500, which is an example of feature table 1408, according to an embodiment of the present invention. As shown in FIG. 15, feature table 1500 includes a list of features 1502a-1502n. Any number of features 1502 may be present in table 1500, in embodiments. Each feature 1502 includes a user attribute 1504, an advertisement attribute 1506, and a weight factor 1508. For example, feature 1502a includes a user attribute 1504a, an advertisement attribute 1506a, and a weight factor 1508a. Feature 1502b includes a user attribute 1504b, an advertisement attribute 1506b, and a weight factor 1508b.

Note that user attributes 1504 may appear in multiple records 1502 with different combinations of advertisement attributes 1506 and weight factors 1508. For example, feature 1502c includes a user attribute 1504c, an advertisement attribute 1506c, and a weight factor 1508c1. User attribute 1504c may appear in another feature 1502 (not shown in FIG. 15), with another advertisement attribute 1506 and weight factor (e.g., weight factor 1508c2).

Example user attributes for user attribute functions 1504, example advertisement attributes for advertisement attribute functions 1506, and example weight factors for weight factors 1508 are described elsewhere herein.

The user attribute 1504, advertisement attribute 1506, and weight factor 1508 of a particular feature 1502 are related according to the second feature type described above. In particular, user attribute 1504 and advertisement attribute 1506 of a particular feature 1502 are related to each other in the form of a logical “AND” function. For example, a user attribute (θᵤ) and an advertisement attribute (θₐ) may each be expressed in a relevance feature as f(user attribute 1504, advertisement attribute 1506) (or as f(θᵤ, θₐ)). The relevance feature may include an “AND” of a of the user attribute θᵤ as g(θᵤ) and a of the advertisement attribute θₐ as h(θₐ) similarly to Equation 1 above, expressed as Equation 2 below:

f(θᵤ, θₐ)=I(g(user attribute 1504)) AND I(h(ad attribute 1506)) Equation 2

where
I( ) is an indicator function.
   Weight factor 1508 indicates a strength of the feature 1502 when Equation 2 is evaluated to be true for the corresponding user attribute 1504 and advertisement attribute 1506. Weight factors 1508 in feature table 1500 may be determined in various ways. For example, weight factors 1508 may be trained using machine learning techniques to predict click probability given the attributes of the user (user attributes 1504), advertisement (advertisement attribute 1506), and/or a world state. Alternatively, weight factors 1508 may be trained using machine learning techniques to predict the relevance of an advertisement to the user.

In step 1304, the list of features is mapped to a plurality of advertisements to generate an index. For example, in an embodiment, advertisement index generator 1402 receives a plurality of advertisements 1406. Advertisements 1406 is a list or other data structure that includes indicators for a plurality of advertisements, and attribute information related to the advertisements.

FIG. 16 shows an advertisements table 1600, which is an example of advertisements 1406, according to an embodiment of the present invention. As shown in FIG. 16, advertisements table 1600 includes a plurality of advertisement records 1602a-1602n. Any number of records 1602 may be present in table 1600, in embodiments. Each advertisement record 1602 includes an advertisement 1604 and a list 1606 of advertisement attribute functions 1608. Each list 1606 may include any number of advertisement attribute functions 1608. For example, list 1606a, corresponding to advertisement 1604a, includes advertisement attribute functions 1608a-1608e. List 1606b, corresponding to advertisement 1604b, includes advertisement attribute functions 1608f-1608h.

In an embodiment, advertisement index generator 1402 maps feature table 1408 to advertisements 1406. The mapping generates an index 1412. Index 1412 relates each advertisement 1604 to a list of key values based on user attribute functions 1504. Referring to feature table 1500 of FIG. 15, and advertisement table 1600 of FIG. 16, index 1412 lists each advertisement 1604 of table 1600, and includes a list for each advertisement 1604 of pairs of user attribute functions 1504 and weight factors 1508. The user attribute 1504 and weight factor 1508 pairs for an advertisement 1604 are mapped from features 1502 of feature table 1500 that include an advertisement attribute 1506 that matches an advertisement attribute 1608 associated with the advertisement 1604.

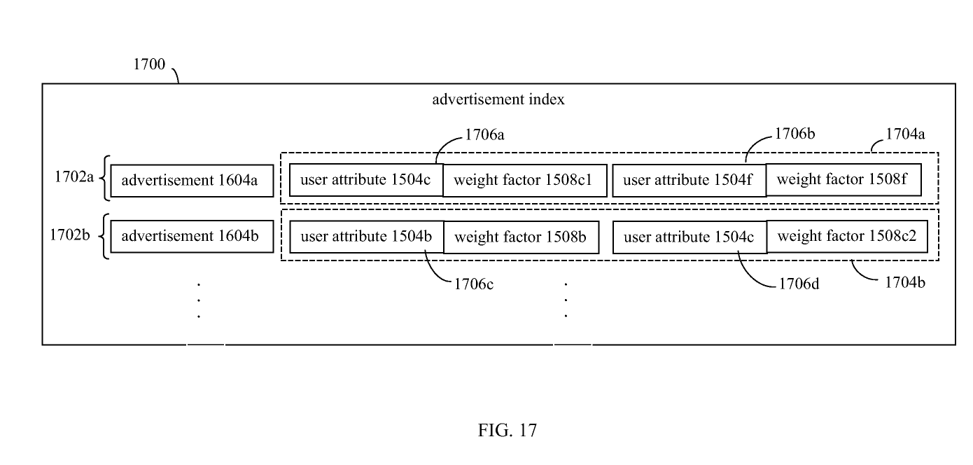

For example, FIG. 17 shows a portion of an advertisement index 1700, which is an example of index 1402, according to an embodiment of the present invention. In the example of FIG. 17, index 1700 includes two advertisement records 1702a and 1702b, for purposes of brevity. Each record 1702 includes a corresponding advertisement 1604 and a list 1704 of pairs of user attributes 1504 and weight factors 1508. For example, record 1702a includes advertisement 1604a and a list 1704a, which includes a first pair 1706a of user attribute 1504c and weight factor 1508c1 and a second pair 1706b of user attribute 1504f and weight factor 1508f. Record 1702b includes advertisement 1604b and a list 1704b, which includes a first pair 1706c of user attribute 1504b and weight factor 1504b and a second pair 1706d of user attribute 1504c and weight factor 1508c2.

In the case of record 1702a, first pair 1706a of user attribute 1504c and weight factor 1508c1 is listed with advertisement 1604a because advertisement attribute 1506c of feature table 1500 matches advertisement attribute 1608a of advertisement 1604a in advertisement table 1600. Second pair 1706b of user attribute 1504f and weight factor 1508f is listed with advertisement 1604a because advertisement attribute 1506f of feature table 1500 matches advertisement attribute 1608b of advertisement 1604a in advertisement table 1600. With regard to record 1702b, first pair 1706c of user attribute 1504b and weight factor 1508b is listed with advertisement 1604b because advertisement attribute 1506b of feature table 1500 matches advertisement attribute 1608f of advertisement 1604b in advertisement table 1600. Second pair 1706d of user attribute 1504c and weight factor 1508c2 is listed with advertisement 1604b because advertisement attribute 1506d (not shown in FIG. 15, but listed with user attribute 1504c and weight factor 1508c2 in feature table 1500) of feature table 1500 matches advertisement attribute 1608g of advertisement 1604g in advertisement table 1600.

In step 1306, an inverted index is generated from the index that lists each user attribute included in the feature table and includes a list for each user attribute of advertisement and weight factor pairs. For example, in an embodiment, index inverter 1404 receives index 1412. Index inverter 1404 inverts index 1412 to generate inverted index 504. To generate inverted index 504, index inverter 1412 lists each user attribute 1504 of index 1412, and for each listed user attribute 1504, a list is generated of each advertisement 1604 that lists the user attribute 1504 and of each corresponding weight factor 1508.

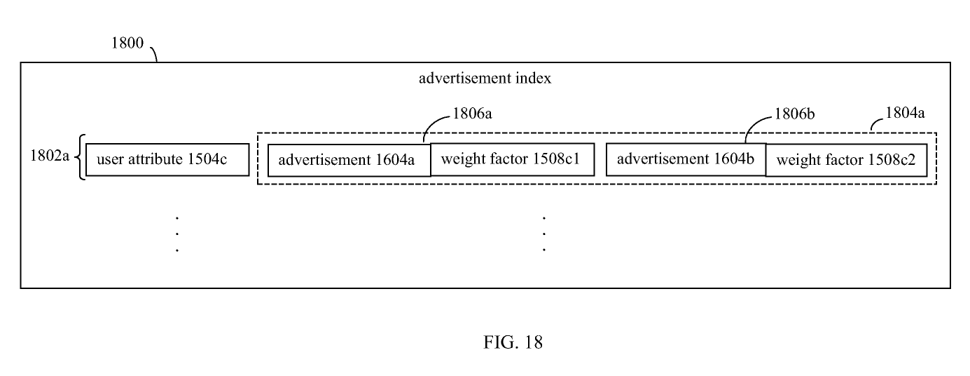

For example, FIG. 18 shows a portion of an inverted index 1800, which is an example of inverted index 504, according to an embodiment of the present invention. In the example of FIG. 18, a single user attribute record 1802a is shown for inverted index 1800, for purposes of brevity. Each record 1802 includes a corresponding user attribute 1504 and a list 1804 of pairs of advertisements 1604 and weight factors 1508. For example, record 1802a includes user attribute 1504c and a list 1804a, which includes a first pair 1806a of advertisement 1604a and weight factor 1504c1 and a second pair 1806b of advertisement 1604f and weight factor 1508c2.

In the case of record 1802a, first pair 1806a of advertisement 1604a and weight factor 1508c1 is listed with user attribute 1504c because user attribute 1504c (and weight factor 1508c1) is listed in list 1704a of advertisement 1604a in advertisement index 1700. Second pair 1806b of advertisement 1604b and weight factor 1508c2 is listed with user attribute 1504c because user attribute 1504c (and weight factor 1508c2) is listed in list 1704b of advertisement 1604b in advertisement index 1700.

### F. Example Computer System Implementations

Note that any one or more of advertisement engine 500 and advertisement selection system 502 shown in FIGS. 5 and 8, advertisement selection system 900, front end module 902, inverted index querier 904, and advertisement filter 906 shown in FIG. 9, front end module 902, location determiner 1102, cookie analyzer 1104, and query rewriter 1106 shown in FIG. 11, advertisement filter 906, advertisement pruner 1202, advertisement ranker 1204, and advertisement presentation selector 1206 shown in FIG. 12, and inverted index generator 1400, advertisement index generator 1402, and index inverter 1404 shown in FIG. 14 may include hardware, software, firmware, or any combination thereof to perform at least a portion of their functions. For example, any one or more may include computer code configured to be executed in one or more processors. Alternatively or additionally, any one or more may include hardware logic/electrical circuitry.

In an embodiment, advertisement engine 500, advertisement selection system 502, advertisement selection system 900, front end module 902, inverted index querier 904, advertisement filter 906, front end module 902, location determiner 1102, cookie analyzer 1104, query rewriter 1106, advertisement filter 906, advertisement pruner 1202, advertisement ranker 1204, advertisement presentation selector 1206, inverted index generator 1400, advertisement index generator 1402, and/or index inverter 1404 may implemented in one or more computers, including a personal computer, a mobile computer (e.g., a laptop computer, a notebook computer, a handheld computer such as a personal digital assistant (PDA) or a Palm™ device, etc.), or a workstation. These example devices are provided herein purposes of illustration, and are not intended to be limiting. Embodiments of the present invention may be implemented in further types of devices, as would be known to persons skilled in the relevant art(s).

Devices in which embodiments may be implemented may include storage, such as storage drives, memory devices, and further types of computer-readable media. Examples of such computer-readable media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable media may store program modules that include logic for implementing advertisement engine 500, advertisement selection system 502, advertisement selection system 900, front end module 902, inverted index querier 904, advertisement filter 906, front end module 902, location determiner 1102, cookie analyzer 1104, query rewriter 1106, advertisement filter 906, advertisement pruner 1202, advertisement ranker 1204, advertisement presentation selector 1206, inverted index generator 1400, advertisement index generator 1402, and/or index inverter 1404, flowchart 1000 of FIG. 10, and flowchart 1300 of FIG. 13, and/or further embodiments of the present invention described herein. Embodiments of the invention are directed to computer program products comprising such logic (e.g., in the form of software) stored on any computer useable medium. Such software, when executed in a processing unit (that includes one or more data processing devices), causes a device to operate as described herein.

### G. Conclusion

While various embodiments of the present invention have been described above, it should be understood that they have been presented by way of example only, and not limitation. It will be apparent to persons skilled in the relevant art(s) that various changes in form and details may be made to the embodiments described above without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for selecting advertisements, comprising:
receiving a request associated with a user for an advertisement;
identifying profile information associated with the user;
querying an inverted index based on the identified profile information, the inverted index including a list of user attributes and a list of at least one advertisement and corresponding weight factor that correspond to each listed user attribute;
determining a plurality of advertisements in the inverted index based on said querying; and
filtering the determined advertisements to generate an advertisement configuration that includes at least one of the determined advertisements.

2. The method of claim 1, wherein said identifying comprises:
determining a user attribute of the user, the determined user attribute of the user being a location associated with the user, a behavioral attribute of the user, a demographic attribute of the user, one or more terms in a search query submitted by the user, or a web page viewed by the user.

3. The method of claim 1, wherein said identifying comprises:
analyzing at least one of a query submitted by the user to a search engine or a cookie associated with a computer of the user.

4. The method of claim 1, wherein said determining comprises:
determining a list of advertisements in the inverted index associated with a user attribute of the identified profile information.

5. The method of claim 1, wherein said filtering comprises:
pruning at least one advertisement from the determined advertisements;
ranking the determined advertisements; and
configuring an arrangement of the determined advertisements.

6. The method of claim 1, wherein said filtering comprises:
performing the filtering based on at least one of a user attribute, an advertisement attribute, a world state attribute, or a non-factorizable combination of a user attribute and an advertisement attribute.

7. The method of claim 5, wherein said configuring an arrangement of the determined advertisements comprises:
configuring the arrangement based on a combination of a user attribute and/or an advertiser attribute and a presentation attribute.

8. The method of claim 7, further comprising:
accessing at least one of an advertisement performance information server, a linead database, a model features table, or a cost model to determine the presentation attribute.

9. A system for selecting advertisements, comprising:
a front end module configured to receive a request associated with a user for an advertisement and to identify profile information associated with the user;
an inverted index querier configured to query an inverted index based on the identified profile information, the inverted index including a list of user attributes and a list of at least one advertisement and corresponding weight factor that correspond to each listed user attribute, the inverted index querier being configured to identify a plurality of advertisements in the inverted index based on the query; and
an advertisement filter configured to filter the identified advertisements to generate an advertisement configuration that includes at least one of the identified advertisements.

10. The system of claim 9, further comprising:
a location determiner configured to determine a location associated with the user as a user location attribute;
a cookie analyzer configured to determine at least one behavioral attribute or demographic attribute of the user; and
a query rewriter configured to associate semantically similar query terms.

11. The system of claim 9, wherein the front end module is configured to analyze at least one of a query submitted by the user to a search engine or a cookie associated with a computer of the user to identify the profile information.

12. The system of claim 9, wherein the inverted index querier is configured to determine a list of advertisements in the inverted index associated with a user attribute of the identified profile information.

13. The system of claim 9, wherein the advertisement filter comprises:
an advertisement pruner configured to prune at least one advertisement from the determined advertisements;
an advertisement ranker configured to rank the determined advertisements; and
an advertisement presentation selector configured to configure an arrangement of the determined advertisements.

14. The system of claim 9, wherein the advertisement filter is configured to filter the determined advertisements based on at least one of a user attribute, an advertisement attribute, a world state attribute, or a non-factorizable combination of a user attribute and an advertisement attribute.

15. The system of claim 14, wherein the advertisement presentation selector is configured to configuring the arrangement of the determined advertisements based on a combination of a user attribute and/or an advertiser attribute and a presentation attribute.

16. The system of claim 15, wherein the advertisement filter is configured to access at least one of an advertisement performance information server, a linead database, a model features table, or a cost model to determine a presentation attribute.

17. A method for indexing user and advertisement information, comprising:
receiving a feature table that includes a list of features, each feature in the list of features including a user attribute, an advertisement attribute, and a weight factor associated with the user attribute and advertisement attribute;
mapping the list of features to a plurality of advertisements to generate an index; and
generating an inverted index from the generated index that lists each user attribute included in the feature table and includes a list for each user attribute of advertisement and weight factor pairs.

18. The method of claim 17, wherein said mapping comprises:
receiving an advertisements table that includes a plurality of advertisement records, each advertisement record including an advertisement and an associated list of advertisement attributes;
generating a list of advertisement records includes each advertisement included in the advertisements table in a corresponding advertisement record; and
for each advertisement record in the generated list of advertisements records, generating a list of user attribute and weight factor pairs extracted from features of the feature table that include an advertisement attribute matching an advertisement attribute in the list of advertisement attributes associated with the advertisement of the advertisement record.

19. The method of claim 18, wherein said generating an inverted index comprises:
generating a list of user attribute records that includes each user attribute in the generated index in a corresponding user attribute record; and
for each user attribute record in the generated list of user attribute records, generating a list of advertisement and weight factor pairs extracted from advertisement records of the generated list of advertisement records that include a user attribute matching the user attribute of the user attribute record.

20. The method of claim 17, further comprising:
determining each weight factor according to a machine learning technique.

21. A system for indexing user and advertisement information, comprising:
an advertisement index generator configured to receive a feature table that includes a list of features, each feature in the list of features including a user attribute, an advertisement attribute, and a weight factor associated with the user attribute and advertisement attribute, the advertisement index generator being configured to map the list of features to a plurality of advertisements to generate an index; and
an index inverter configured to generate an inverted index from the generated index that lists each user attribute included in the feature table and includes a list for each user attribute of advertisement and weight factor pairs.

22. The system of claim 21, wherein the advertisement index generator is configured to receive an advertisements table that includes a plurality of advertisement records, each advertisement record including an advertisement and an associated list of advertisement attributes;
wherein the advertisement index generator is configured to generate a list of advertisement records includes each advertisement included in the advertisements table in a corresponding advertisement record; and
wherein for each advertisement record in the generated list of advertisements records, the advertisement index generator is configured to generate a list of user attribute and weight factor pairs extracted from features of the feature table that include an advertisement attribute matching an advertisement attribute in the list of advertisement attributes associated with the advertisement of the advertisement record.

23. The system of claim 22, wherein the index inverter is configured to generate a list of user attribute records that includes each user attribute in the generated index in a corresponding user attribute record; and
wherein for each user attribute record in the generated list of user attribute records, the index inverter is configured to generate a list of advertisement and weight factor pairs extracted from advertisement records of the generated list of advertisement records that include a user attribute matching the user attribute of the user attribute record.
